(19) United States
(12) Patent Application Publication
(10) Pub. No.: US 2012/0133143 A1
(43) Pub. Date: May 31, 2012

(54) LIGHTNING STRIKE DETECTOR FOR HOLLOW STRUCTURE, WIND TURBINE ROTOR BLADE, AND WIND TURBINE GENERATOR EQUIPPED WITH THE SAME

(75) Inventors: Musashi KIMURA, Tokyo (JP); Takehiro NAKA, Tokyo (JP); Kentaro HAYASHI, Tokyo (JP)

(73) Assignee: MITSUBISHI HEAVY INDUSTRIES, LTD., Tokyo (JP)

(21) Appl. No.: 13/304,549

(22) Filed: Nov. 25, 2011

(30) Foreign Application Priority Data
Nov. 30, 2010 (JP) 2010-267717

(51) Int. Cl. F03D 9/00; F03D 11/00; H02H 3/00

(52) U.S. Cl. 290/55; 361/78; 416/61

(57) ABSTRACT

A lightning strike detector that can promptly detect a lightning strike to ensure safety and can accurately determine the position struck by the lightning with a simple, inexpensive, and highly reliable structure, is provided. The lightning strike detector includes an environment-detecting sensor member that detects a change in the environment of the internal space of a wind turbine blade, serving as a hollow structure, when the wind turbine blade is struck by lightning and is damaged, converts the environmental change into an electrical signal, and outputs the electrical signal; and a control unit (nacelle-side control system and ground-side control system) that receives the electrical signal, judges whether a lightning strike has occurred, and takes countermeasures against the lightning strike.

### CROSS-REFERENCE TO RELATED APPLICATIONS

This application is based on Japanese Patent Application No. 2010-267717, the contents of which are incorporated herein by reference.

### BACKGROUND OF THE INVENTION

1. Field of the Invention

The present invention relates to a lightning strike detector, for a hollow structure, which is capable of judging the presence or absence of a lightning strike and the position struck by the lightning, and relates to a wind turbine rotor blade and a wind turbine generator having the detector.

2. Description of Related Art

A standard wind turbine generator includes a wind turbine rotor blade having several wind turbine blades extending radially, centered on a rotor head, and the rotor head is pivotally supported by a nacelle that is supported on the top end of a tower so as to be horizontally rotatable. The wind turbine generator is constituted so that a generator disposed inside the nacelle is driven by rotation of the wind turbine rotor blade to generate electricity.

In this type of wind turbine generator, the wind turbine blades in particular tend to be struck by lightning. Accordingly, the wind turbine blades are provided with receptors (lightning receptor members) as arresters, as disclosed in Japanese Unexamined Patent Application, Publication No. 2010-223148. The receptors are disposed at several points on each wind turbine blade, including the blade tip ends, which tend to be mostly struck by lightning, and a lightning conductor (down conductor) extends from each receptor, passes through inside the wind turbine blade, the nacelle, and the tower, and is earthed to ground. Thus, the lightning current due to a lightning strike on the receptor is introduced into the ground to prevent the wind turbine blade from being damaged.

Furthermore, in addition to the receptors, recently, metal pieces called diverter strips are discontinuously attached to the blade surfaces. The diverter strips allow lightning current due to a lightning strike on the blade at places other than the receptors to flow along the surface of the wind turbine blade through each diverter strip and introduce the current to any receptor. By doing so, there is no need to provide each diverter strip with a lightning conductor, and, accordingly, the lightning resistance of the wind turbine blade can be improved with a simple structure.

However, such receptors and diverter strips cannot completely protect wind turbine blades from a large number of lightning strikes, and the wind turbine blades are often damaged by lightning strikes. Continuously operating the wind turbine blades without recognizing the damage caused by a lightning strike may lead to a serious accident. Therefore, prompt detection and repair of damage caused by a lightning strike are necessary.

In the related art, there is a lightning strike detector for recognizing a lightning strike by detecting lightning current with a large diameter Rogowski coil disposed so as to surround, in the form of a circle, the tower base of a wind turbine generator, as disclosed in Japanese Patent No. 4211924.

However, in the existing technology such as that disclosed in Japanese Patent No. 4211924, a lightning strike on the whole wind turbine generator can be detected, but it is not possible to detect, for example, which blade of the wind turbine rotor blade is struck by lightning. Accordingly, prompt repair is difficult to implement. The position struck by lightning can be specified by providing the wind turbine blades with a large number of devices, such as Rogowski coils, for electrically detecting lightning current. However, Rogowski coils are expensive and are also difficult to install, thus making the structure of the entire lightning strike detector complicated and expensive, resulting in an increase in construction costs of the wind turbine generator.

### BRIEF SUMMARY OF THE INVENTION

The present invention has been made in view of the above circumstances, and an object thereof is to provide a lightning strike detector, for a hollow structure, which is capable of promptly detecting a lightning strike to ensure safety and which is capable of accurately determining the position struck by the lightning with a simple, inexpensive, and reliable structure and to provide a wind turbine rotor blade and a wind turbine generator equipped with the detector.

The present invention employs the following solutions for solving the above-mentioned problems.

That is, a first aspect of a lightning strike detector for a hollow structure according to the present invention includes an environmental-change detecting unit that detects a change in the environment of an internal space of the hollow structure caused by damage to the hollow structure due to a lightning strike, converts the change in environment into an electrical signal, and outputs the electrical signal; and a control unit that receives the electrical signal, judges whether a lightning strike has occurred, and takes countermeasures against the lightning strike.

According to the above-mentioned configuration, when lightning strikes on a hollow structure, a change in the internal environment of the hollow structure is detected by the environmental-change detecting unit, the change is converted into an electrical signal, and the electrical signal is outputted to the control unit. The control unit receives this electrical signal and takes countermeasures against the lightning strike. As a result, the lightning strike can be promptly detected, and safety can be ensured.

The change in the internal environment of the hollow structure due to a lightning strike can be detected with a relatively simple configuration by using the environmental-change detecting unit as a sensor. Accordingly, the occurrence of a lightning strike can be accurately judged with a simple, inexpensive, and highly reliable structure.

In a second aspect of the lightning strike detector for a hollow structure according to the present invention, when the hollow structure in the first aspect is a structural member of a mechanical working system, the countermeasures against the lightning strike include halting the operation of the mechanical working system, determining the position struck by the lightning, and reporting to the manager.

According to the above-mentioned configuration, when the hollow structure of a mechanical working system is struck by lightning, the operation of the mechanical working system is halted, and the position struck by the lightning is determined, and reporting to a manager is conducted. Accordingly, the safety of the mechanical working system itself and the surroundings is ensured, the manager of the mechanical working system can immediately recognize the occurrence of the lightning strike, and work such as inspection and repair of the damaged portion can be quickly started.

In a third aspect of the lightning strike detector for a hollow structure according to the present invention, the control unit according to the second aspect performs signal processing to cancel a regular fluctuation involved in normal operation of the mechanical working system, in the electrical signal output from the environmental-change detecting unit.

According to the above-mentioned configuration, for example, even if the environmental-change detecting unit senses a small regular fluctuation that is involved in the normal operation of a mechanical working system and outputs the fluctuation as an electrical signal, the electrical signal showing such a small pressure fluctuation is cancelled to prevent a situation where a mechanical working system that has not been actually struck by lightning is erroneously judged to be struck by lightning, resulting in enhanced reliability of the lightning strike detector.

In a fourth aspect of the lightning strike detector for a hollow structure according to the present invention, in any one of the first to third aspects, the internal space of the hollow structure is partitioned by a partition wall into a plurality of divided chambers, the divided chambers are each provided with the environmental-change detecting unit, the environmental-change detecting units individually output electrical signals to the control unit based on changes in the environment in the divided chambers, and the control unit distinguishes the electrical signals to determine the position struck by the lightning.

According to the above-mentioned configuration, when a hollow structure is struck by lightning, a change in the internal environment occurs only in the divided chamber corresponding to the position struck by the lightning, among the plurality of divided chambers formed in the internal space of the hollow structure. This change in the internal environment is detected by the environmental-change detecting unit disposed in each of the divided chambers, and this environmental-change detecting unit outputs a specific electrical signal to the control unit. Accordingly, the control unit distinguishes the received electrical signals and can easily identify the position of the environmental-change detecting unit that has outputted the electrical signal, i.e., the position of the divided chamber struck by lightning. Therefore, the position of a lightning strike can be reliably determined.

In a fifth aspect of the lightning strike detector for a hollow structure according to the present invention, in any one of the first to fourth aspects, the environmental-change detecting unit is a photoelectric conversion sensor and is disposed in the internal space of the hollow structure, which is formed as a dark chamber.

According to the above-mentioned configuration, if the outer surface of the hollow structure is damaged by a lightning strike, the lightning light or the outside light enters the internal space of the hollow structure through this damaged portion. This causes a change in the luminous environment of the internal space formed like a dark chamber.

The photoelectric conversion sensor disposed in the internal space as the environmental-change detecting unit detects a change in the luminous environment, i.e., an increase in the amount of light received, converts the change into an electrical signal, and outputs the electrical signal to the control unit. The control unit receives the electrical signal and takes countermeasures against the lightning strike.

Accordingly, a lightning strike can be promptly detected, ensuring safety. The photoelectric conversion sensor is inexpensive, can be readily installed, and operates reliably, thus enabling the lightning strike detector to have a highly reliable structure.

In a sixth aspect of the lightning strike detector for a hollow structure according to the present invention, in any one of the first to fourth aspects, the environmental-change detecting unit is a piezoelectric conversion sensor and is disposed in the internal space of the hollow structure, which is formed as an airtight chamber.

According to the above-mentioned configuration, if the outer surface of the hollow structure is damaged by a lightning strike, the pressure inside the internal space of the hollow structure sharply increases. This causes a change in the pressure environment in the internal space formed like an airtight chamber.

The piezoelectric conversion sensor disposed in the internal space as the environmental-change detecting unit detects the change in the pressure environment, i.e., an increase in pressure, converts the change into an electrical signal, and outputs the electrical signal to the control unit. The control unit receives the electrical signal and takes countermeasures against the lightning strike.

Accordingly, a lightning strike can be promptly detected, thus ensuring safety. The piezoelectric conversion sensor is inexpensive, can be readily installed, and operates reliably, thus enabling the lightning strike detector to have a highly reliable structure.

A wind turbine rotor blade according to another aspect of the present invention includes the lightning strike detector for the hollow structure according to any of the first to the sixth aspects. By doing so, a lightning strike on the wind turbine rotor blade can be promptly detected to ensure safety and the position struck by the lightning can be determined with a simple, inexpensive, and highly reliable structure.

A wind turbine generator according to another aspect of the present invention includes the wind turbine rotor blade described above. By doing so, a lightning strike on the wind turbine rotor blade of the wind turbine generator can be promptly detected, to ensure safety, and the position struck by the lightning can be determined with a simple, inexpensive, and highly reliable structure.

As described above, according to the lightning strike detector for a hollow structure, the wind turbine rotor blade, and the wind turbine generator having the detector according to the present invention, a lightning strike can be promptly detected to ensure safety, and the position struck by the lightning can be reliably determined, with a simple, inexpensive, and highly reliable structure.

### BRIEF DESCRIPTION OF THE SEVERAL VIEWS OF THE DRAWINGS

FIG. 1 is a side view of an example of a wind turbine generator provided with a lightning strike detector for a hollow structure according to the present invention.

FIG. 2 is a perspective view of a wind turbine blade provided with the lightning strike detector according to a first embodiment of the present invention.

FIG. 3 is a perspective view illustrating a state in which the wind turbine blade, equipped with the lightning strike detector shown in FIG. 2, is damaged by a lightning strike.

FIG. 4 is a diagram showing a flow chart of the control flow for the lightning strike detector.

FIG. 5 is a perspective view of a wind turbine blade provided with the lightning strike detector according to a second embodiment of the present invention.

FIG. 6 is a perspective view illustrating a state in which the wind turbine blade, equipped with the lightning strike detector shown in FIG. 5, is damaged by a lightning strike.

### DETAILED DESCRIPTION OF THE INVENTION

Embodiments of the wind turbine generator according to the present invention will be described below with reference to the drawings.

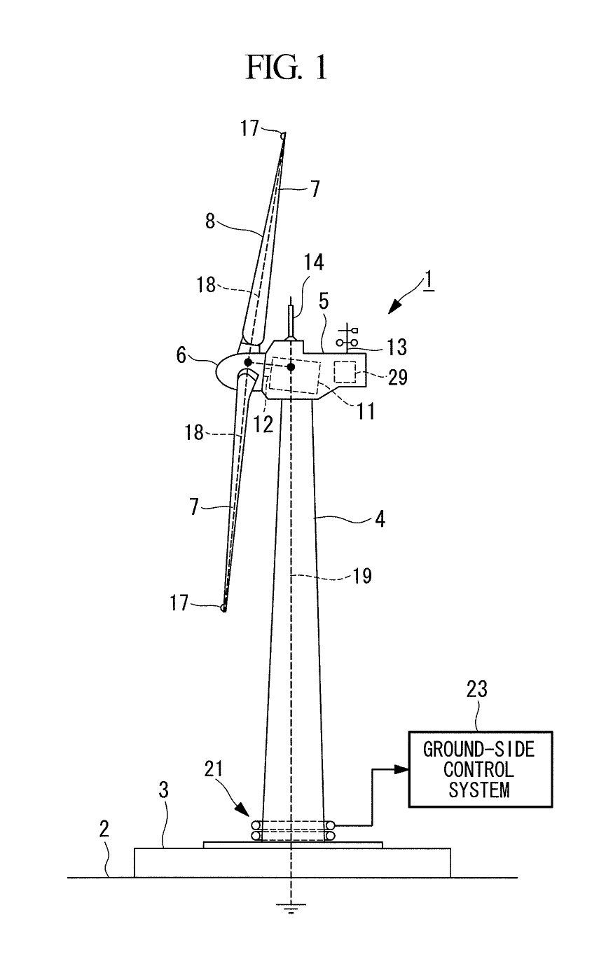

FIG. 1 is a side view of an example of a wind turbine generator in which the lightning strike detector for a hollow structure according to the present invention is applied to each wind turbine blade 7. This wind turbine generator (mechanical working system) 1 includes, for example, a tower 4 erected on a reinforced-concrete base 3 disposed on the ground 2, a nacelle 5 disposed on the top end of the tower 4, and a rotor head 6 supported on the front end of the nacelle 5 so as to be rotatable around a rotor shaft in an approximately horizontal transverse direction.

The rotor head 6 has a plurality of (e.g., three) radially extending wind turbine blades (hollow structures) 7 attached thereto to form a wind turbine rotor blade 8. A generator 11 is disposed inside the nacelle 5, and a rotor shaft 12 of the rotor head 6 is connected to a main shaft of the generator 11 via a gear box (not shown). Thus, the wind force of external wind hitting the wind turbine blades 7 is converted into a rotation force that rotates the wind turbine rotor blade 8 and the rotor shaft 12 to drive the generator 11, thus generating electricity.

The nacelle 5 can turn together with the wind turbine rotor blade 8 in the horizontal direction on the top end of the tower 4. A wind direction/speed measuring device 13 for measuring peripheral wind direction and speed values and a lightning rod 14 for avoiding lightning strikes are disposed at suitable places (e.g., the upper portion) on the outer peripheral surface of the nacelle 5. The nacelle 5 is controlled by a driving gear and a control system (not shown) so as to always point upwind, thereby efficiently generating electricity. The pitch angles of the wind turbine blades 7 are automatically adjusted so as to allow the wind turbine rotor blade 8 to most efficiently rotate in response to air flow. The nacelle 5, the wind turbine blades 7, etc., are hollow structures formed of, for example, FRP.

The three wind turbine blades 7 are each provided with a receptor 17 at the end thereof. The receptor 17 is a known lightning protecting member and is usually formed into a circular shape having a diameter of several centimeters or a shape that follows the blade tip shape and is fixed to the surface of the wind turbine blade 7 with an adhesive or the like. Wind-turbine-blade lightning conductors (down conductors) 18 are arranged so as to extend from the respective receptors 17 to the blade roots through the inside of the wind turbine blades 7. These three wind-turbine-blade lightning conductors 18 are united into one inside the rotor head 6 and are electrically connected to a tower lightning conductor 19 arranged inside the tower 4 via, for example, a known slip ring (not shown). The aforementioned lightning rod 14 is also electrically connected to the tower lightning conductor 19, and the lower end of the tower lightning conductor 19 is earthed to ground.

Accordingly, if the lightning rod 14 or the receptor 17 is struck by lightning, the lightning current is conducted into the ground through the wind-turbine-blade lightning conductor 18 and the tower lightning conductor 19 to prevent the wind turbine blades 7 and the nacelle 5 from being damaged by the lightning strike. At the base of the tower 4, a lightning strike detecting unit 21 employing a known Rogowski coil is installed. This lightning strike detecting unit 21 detects the lightning current passing through the tower lightning conductor 19 and outputs an electrical signal thereof to a ground-side control system (control unit) 23. The ground-side control system 23 can recognize the lightning strike, store the information, and report it to the manager of the wind turbine generator.

As described above, in the case of a lightning strike on the lightning rod 14 provided on the nacelle 5 or the receptor 17 provided on each wind turbine blade 7, the lightning current is conducted to the ground through the wind-turbine-blade lightning conductor 18 and the tower lightning conductor 19. Consequently, the wind turbine generator 1 is hardly damaged. However, in the case of a lightning strike on a position other than the lightning rod 14 and the receptors 17, the wind turbine generator 1 is damaged, and if the lightning current in such a case does not pass through the tower lightning conductor 19, the lightning strike is not detected by the lightning strike detecting unit 21 employing the Rogowski coil. Consequently, the wind turbine generator 1 may continue to be operated without recognizing the damage. Accordingly, in the present invention, individual lightning strike detectors are disposed on the wind turbine blades 7, which tend to be most frequently struck by lightning.

### FIRST EMBODIMENT

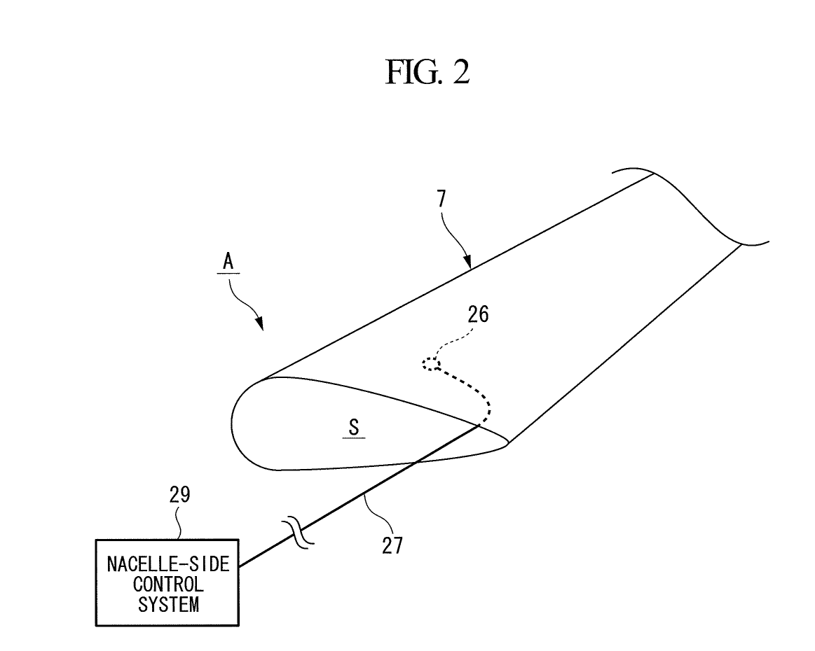

FIG. 2 is a perspective view of a wind turbine blade 7 provided with a lightning strike detector A according to a first embodiment of the present invention. In this lightning strike detector A, an environment-detecting sensor member 26 is disposed in the internal space S of the wind turbine blade 7, which is a hollow structure. This environment-detecting sensor member 26 functions as an environmental-change detecting unit that detects a change in the environment in the internal space S of the wind turbine blade 7 when the wind turbine blade 7 is struck by lightning and is damaged, converts this change in the environment into an electrical signal, and outputs the electrical signal. For example, a photoelectric conversion sensor or a piezoelectric conversion sensor is used as the environment-detecting sensor member 26. Furthermore, both of these sensors may be used in combination.

In the case where a photoelectric conversion sensor is used as the environment-detecting sensor member 26, the internal space S of the wind turbine blade 7 is formed like a dark chamber. It is preferable to fix the environment-detecting sensor member 26 to the blade root portion of the wind turbine blade 7 so that the light-detecting direction (light receiver) points to the blade tip end. In the case where a piezoelectric conversion sensor is used as the environment-detecting sensor member 26, the internal space S of the wind turbine blade 7 is formed like an airtight chamber, and the environment-detecting sensor member 26 is fixed to the inner wall of the internal space S.

Furthermore, a harness 27 extending from the environment-detecting sensor member 26 is connected to a nacelle-side control system (control unit) 29 disposed, for example, inside the nacelle 5. The electrical connection between the environment-detecting sensor member 26, which rotates together with the wind turbine blade 7, and the nacelle-side control system 29, which does not rotate, may be wired communication through a slip ring, as in the lightning conductors 18 and 19, or may be noncontact communication (e.g., wireless communication). The connection between the nacelle-side control system 29 and the above-described ground-side control system 23 may be wired communication or wireless communication.

The nacelle-side control system 29 and the ground-side control system 23 function as control units for the lightning strike detector A and judge the reception of the electrical signal output from the environment-detecting sensor member 26 as the occurrence of damage caused by a lightning strike on the wind turbine blade 7 and take countermeasures against the lightning strike. Such countermeasures against a lightning strike include halting the operation of the wind turbine generator 1, determining the position struck by the lightning on the basis of the location of the environment-detecting sensor member 26, storing the information, and reporting to the manager. Each of the wind turbine blades 7 is provided with at least one environment-detecting sensor member 26, and the input of an electrical signal from a specific environment-detecting sensor member 26 means that the specific wind turbine blade 7 having the environment-detecting sensor member 26 was struck by lightning. Even if the ground-side control system 23 is installed at a place remote from the wind turbine generator, the wind turbine blade 7 that has been struck by lightning can be identified.

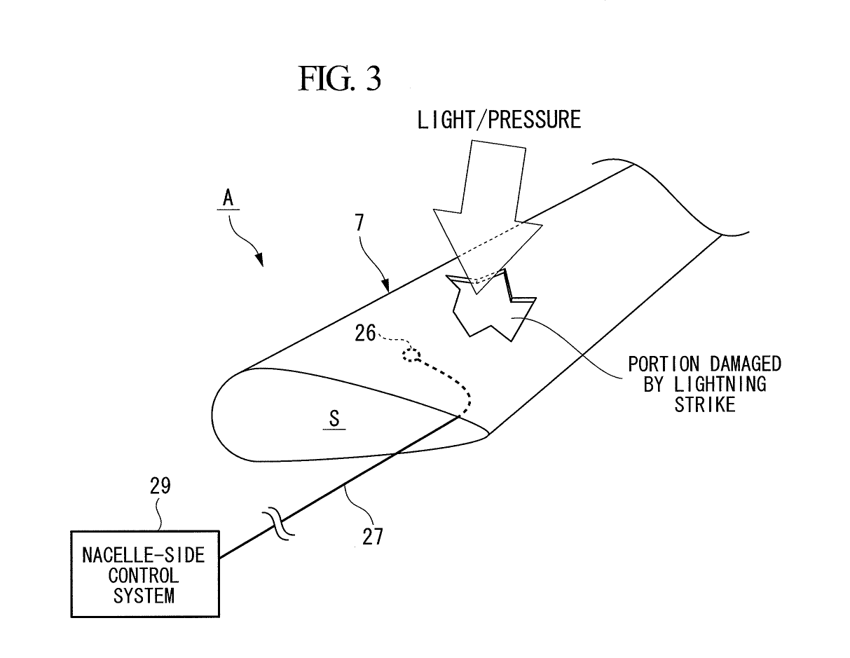

In the wind turbine generator 1 provided with the thus-configured lightning strike detector A, when any of the three wind turbine blades 7 is damaged by a lightning strike, causing a hole or breakage, as shown in FIG. 3, the lightning light or outside light enters the internal space S of the wind turbine blade 7 through this portion damaged by the lightning strike, and, at the same time, the external pressure that has instantaneously increased due to the lightning strike enters the internal space S to cause a large change in the internal environment of the wind turbine blade 7. Then, this change in the internal environment is detected by the environment-detecting sensor member 26.

For example, in the case where the environment-detecting sensor member 26 is a photoelectric conversion sensor and the internal space S of the wind turbine blade 7 is formed like a dark chamber, external light enters through the portion damaged by the lightning strike, increasing the brightness of the internal space S, which was dark before the lightning strike, and the environment-detecting sensor member 26 (photoelectric conversion sensor) detects this increase in the amount of light received. In the case where the environment-detecting sensor member 26 is a piezoelectric conversion sensor and the internal space of the wind turbine blade 7 is formed like an airtight chamber, the external pressure enters through the portion damaged by a lightning strike to sharply increase the internal pressure of the internal space S, and the environment-detecting sensor member 26 (piezoelectric conversion sensor) detects this increase in pressure.

The environment-detecting sensor member 26 then converts the thus-detected change in the environment of the internal space S into an electrical signal and outputs the electrical signal to the nacelle-side control system 29, and the nacelle-side control system 29 transmits the electrical signal to the ground-side control system 23. The nacelle-side control system 29 and the ground-side control system 23 take countermeasures as described above: for example, the operation of the wind turbine generator 1 is first stopped, the position struck by the lightning is then determined (identification of the wind turbine blade 7 struck by lightning) on the basis of the location of the environment-detecting sensor member 26, and the information is stored and reported to a manager. Accordingly, the occurrence of a lightning strike is promptly detected to ensure the safety of the wind turbine generator 1 itself and the surroundings, and the manager of the wind turbine generator 1 can immediately recognize the occurrence of the lightning strike to promptly start work such as inspection and repair of the damaged portion.

As described above, with a configuration in which a change in the environment of the internal spaces S of the wind turbine blade 7 is monitored by the environment-detecting sensor member 26, the configuration of the lightning strike detector A can be relatively simple and lightweight. Accordingly, the occurrence of a lightning strike can be accurately judged with a highly reliable structure that is simple, inexpensive, and suitable for the wind turbine generator 1. In the case where a photoelectric conversion sensor is used as the environment-detecting sensor member 26, damage to the wind turbine blades 7 caused by collision by birds, flying objects, etc. with the wind turbine blades 7 can also be detected in the same way as damage by lightning strikes.

Incidentally, in the case where a piezoelectric conversion sensor is used as the environment-detecting sensor member 26, the inside of the internal space S of the wind turbine blade 7 intrinsically possesses small pressure fluctuations (i.e., regular fluctuations) due to rotation and pitch variation of the wind turbine blade in normal operation of the wind turbine generator 1. Accordingly, it is preferable to process a signal outputted from the environment-detecting sensor member 26 (piezoelectric conversion sensor) by, for example, first transmitting the signal to an oscilloscope disposed in the nacelle-side control system 29 and performing signal processing to cancel the small pressure fluctuations with, for example, a high-pass filter. By performing such control, even if the environment-detecting sensor member 26 senses a small pressure fluctuation, i.e., regular fluctuation, such a small pressure fluctuation is neglected. Therefore, it is possible to avoid a situation where the wind turbine blade 7 that has not been actually struck by lightning is erroneously judged to be struck by lightning, resulting in a notable enhancement in reliability of the lightning strike detector A.

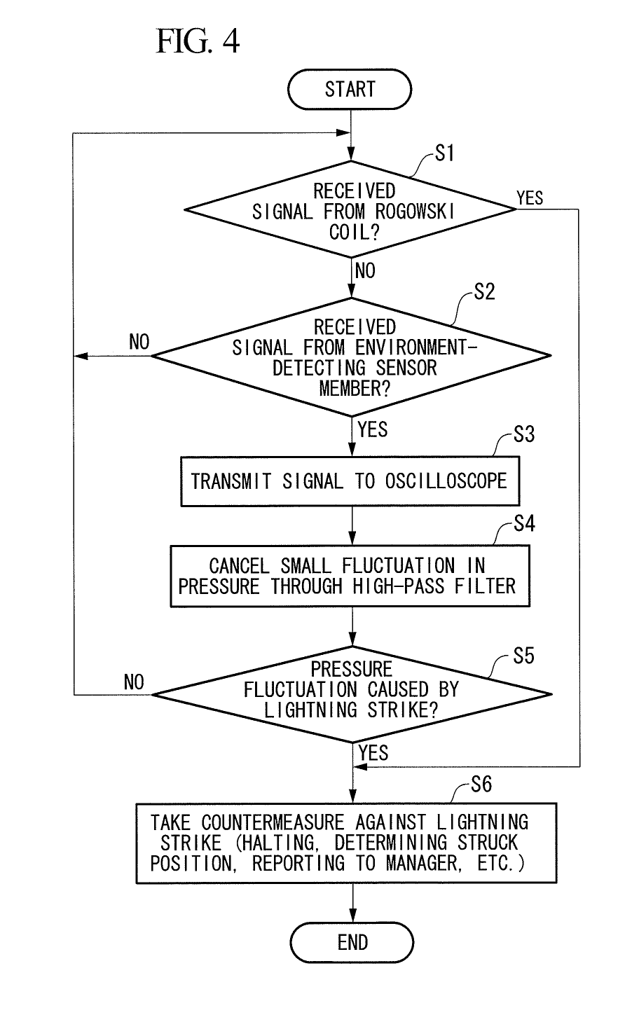

FIG. 4 is a diagram showing a flow chart of the control flow for the lightning strike detector A. After starting this control, it is judged in step S1 whether or not a signal is received from the lightning strike detecting unit 21 which uses a Rogowski coil. If the judgment in step S1 is YES, the flow goes to step S6, where countermeasures against a lightning strike are taken by the nacelle-side control system 29 and the ground-side control system 23, i.e., halting the operation, determining the position struck by the lightning, and reporting to a manager, etc.

If the judgment in step S1 is NO, the flow goes to step S2, where it is judged whether or not a signal is received from the environment-detecting sensor member 26. If the judgment in step S2 is NO, it is determined that a lightning strike has occurred, and the flow returns to step S1, whereupon steps S1 and S2 are repeated.

If the judgment in step S2 is YES, in the case where a photoelectric conversion sensor is used as the environment-detecting sensor member 26, steps S3 to S5 are omitted, and the flow goes to step S6, where countermeasures against a lightning strike are taken by the nacelle-side control system 29 and the ground-side control system 23, i.e., halting the operation, determining the position struck by the lightning, and reporting to the manager, whereupon control is completed.

If the judgment in step S2 is YES, in the case where a piezoelectric conversion sensor is used as the environment-detecting sensor member 26, the flow goes to step S3, where the signal is transmitted from the environment-detecting sensor member 26 to an oscilloscope, and then goes to step S4, where signal processing is performed to cancel the small pressure fluctuation (regular fluctuation) with a high-pass filter.

Subsequently, the flow goes to step S5, where it is judged whether or not a signal component still showing a pressure fluctuation is detected after the above-mentioned signal processing, that is, whether or not the pressure fluctuation is caused by an actual lightning strike. If the judgment in this step S5 is YES, the flow goes to step S6, where countermeasures against a lightning strike are taken by the nacelle-side control system 29 and the ground-side control system 23, i.e., halting the operation, determining the position struck by the lightning, and reporting to the manager, whereupon control is completed.

If the judgment in step S5 is NO, for example, when the environment-detecting sensor member 26 incorrectly detects a pressure fluctuation caused by deflection of the wind turbine blade 7 due to strong wind, instead of a lightning strike, the flow returns to step S1, and the subsequent steps are repeated.

### SECOND EMBODIMENT

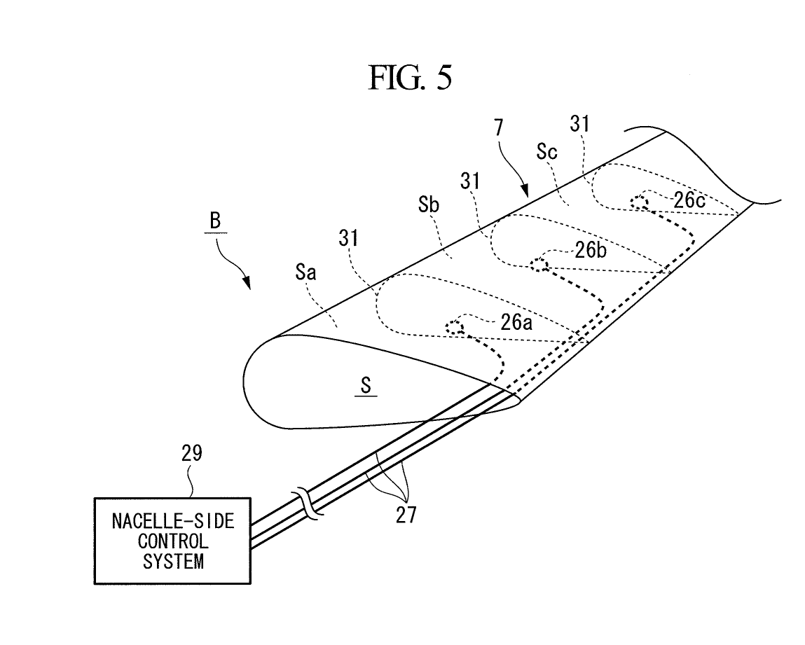

FIG. 5 is a perspective view of a wind turbine blade 7 provided with the lightning strike detector B according to a second embodiment of the present invention. In this lightning strike detector B, the internal space S of the wind turbine blade 7 is partitioned by partition walls 31 into a plurality of divided chambers Sa, Sb, and Sc, and these divided chambers Sa, Sb, and Sc are provided with environment-detecting sensor members 26a, 26b, and 26c, respectively. Photoelectric conversion sensors or piezoelectric conversion sensors are used as these environment-detecting sensor members 26a, 26b, and 26c, as in the lightning strike detector A of the First Embodiment. These environment-detecting sensor members 26a, 26b, and 26c each output a specific electrical signal depending on a change in the environment in each of the divided chambers Sa, Sb, and Sc, i.e., a change in brightness or pressure. The nacelle-side control system 29 and the ground-side control system 23 distinguish such electrical signals to determine the position struck by lightning.

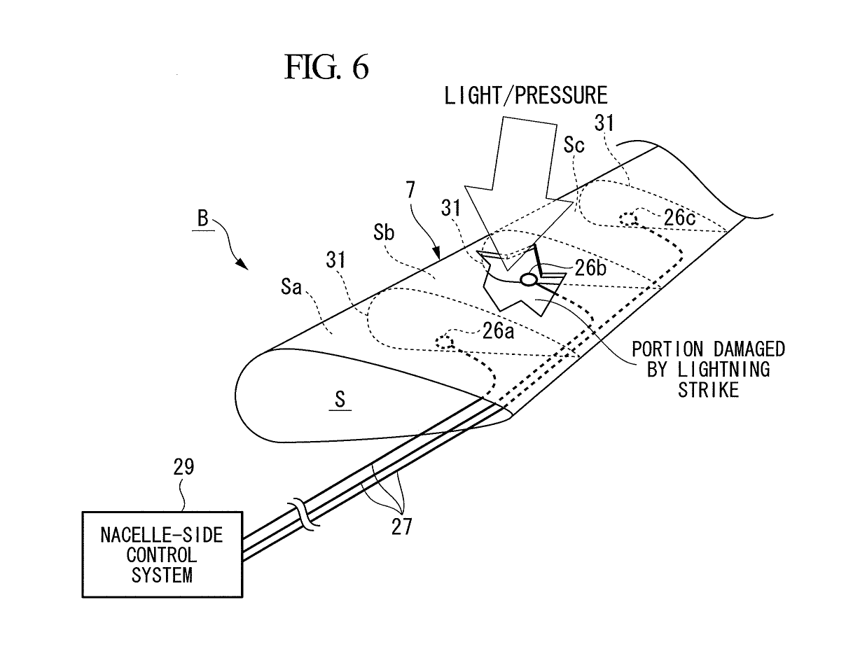

That is, as shown in FIG. 6, among the plurality of divided chambers Sa, Sb, and Sc formed by dividing the internal space S of the wind turbine blade 7, for example, if lightning struck on a position corresponding to the divided chamber Sb, the environment, such as the brightness or pressure, inside the divided chamber Sb changes, and only the environment-detecting sensor member 26b disposed in the divided chamber Sb detects this change in environment and outputs the detection signal to the nacelle-side control system 29. The environments of the other divided chambers Sa and Sc do not change, and therefore the other environment-detecting sensor members 26a and 26c do not output detection signals. As a result, the nacelle-side control system 29 and the ground-side control system 23 can easily identify the position of the divided chamber Sb struck by the lightning from the position information about the environment-detecting sensor member 26b that outputted the electrical signal. Thus, the divided chamber Sb is identified as the position struck by the lightning.

By applying the thus-configured lightning strike detector A according to the First Embodiment or the lightning strike detector B according to the Second Embodiment to the wind turbine blades 7 (wind turbine rotor blade 8), the presence or absence of a lightning strike on the wind turbine blades 7 and the position struck by the lightning can be determined with a simple, inexpensive, and reliable structure. Incidentally, in the First and Second Embodiments, the wind turbine blades 7 are given as examples of hollow structures, but the lightning strike detector A or B may also be applied to other components having hollow structures, such as the nacelle 5.

In each of the above-described Embodiments, a change in brightness and a change in pressure are given as examples of changes in the environment in the internal space S of a hollow structure such as the wind turbine blade 7, and a photoelectric conversion sensor and a piezoelectric conversion sensor are given as examples of the environment-detecting sensor member 26 for detecting a change. However, the sensor member is not limited thereto, and a sensor that detects another change in the environment due to a lightning strike may be used. For example, the loud sound of a lightning strike may be detected with a sound volume sensor or the smell due to a lightning strike may be detected with an odor sensor. Alternatively, for example, breakage of the outer surface of a hollow structure may be detected by enclosing a gas that does not contain an oxygen component in the internal space S of the hollow structure, such as the wind turbine blade 7, disposing an O₂ sensor inside the hollow structure as the environment-detecting sensor member 26, and using the O₂ sensor to sense the oxygen component contained in the outside air, which flows into the internal space S when the outer surface of the hollow structure has been broken.

Thus, various types of sensors can be used as the environment-detecting sensor member 26. Accordingly, the lightning strike detectors A and B can be easily designed, and by simultaneously using a plurality of types of sensors, even if one sensor does not function, another sensor detects a lightning strike, thus achieving reliable lightning strike detection performance.

Incidentally, the lightning strike detector according to the present invention can be applied not only to the wind turbine rotor blade of wind turbine generators but also to other wind turbine rotor blades, and, in addition to wind turbine generators, can be widely applied to, for example, other structures and many mobile objects.

What is claimed is:

1. A lightning strike detector for a hollow structure, the detector comprising:
an environmental-change detecting unit that detects a change in an environment of an internal space of the hollow structure caused by damage to the hollow structure due to a lightning strike, converts the change in the environment into an electrical signal, and outputs the electrical signal; and
a control unit that receives the electrical signal, judges occurrence of the lightning strike, and takes countermeasures against the lightning strike.

2. The lightning strike detector for a hollow structure according to claim 1, wherein the hollow structure is a structural member of a mechanical working system, and the countermeasures against the lightning strike include halting an operation of the mechanical working system, determining a position struck by the lightning, and reporting to a manager.

3. The lightning strike detector for a hollow structure according to claim 2, wherein the control unit performs signal processing to cancel a regular fluctuation involved in normal operation of the mechanical working system in the electrical signal output from the environmental-change detecting unit.

4. The lightning strike detector for a hollow structure according to claim 1, wherein the internal space of the hollow structure is partitioned by a partition wall into a plurality of divided chambers, the divided chambers are each provided with the environmental-change detecting unit, the environmental-change detecting units individually output electrical signals to the control unit based on changes in the environment in the divided chambers, and the control unit distinguishes the electrical signals to determine a position struck by the lightning.

5. The lightning strike detector for a hollow structure according to claim 1, wherein the environmental-change detecting unit is a photoelectric conversion sensor and is disposed in the internal space of the hollow structure, which is formed as a dark chamber.

6. The lightning strike detector for a hollow structure according to claim 1, the environmental-change detecting unit is a piezoelectric conversion sensor and is disposed in the internal space of the hollow structure, which is formed as an airtight chamber.

7. A wind turbine rotor blade having the lightning strike detector for a hollow structure according to claim 1.

8. A wind turbine generator having the wind turbine rotor blade according to claim 7.
